(19) United States
(12) Patent Application Publication
(10) Pub. No.: US 2010/0169760 A1
(43) Pub. Date: Jul. 1, 2010

(54) APPARATUS FOR DISPLAYING INSTANCE DATA, METHOD, AND COMPUTER PROGRAM PRODUCT

(75) Inventor: Akira Hosokawa, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/561,444

(22) Filed: Sep. 17, 2009

(30) Foreign Application Priority Data
Dec. 26, 2008 (JP) 2008-333287

(51) Int. Cl. G06F 17/21

(52) U.S. Cl. 715/227; 715/255

(57) ABSTRACT

An information editing supporting apparatus receives an operation performed by a user. In a case where the operation related to editing of property values or referencing of property values, the apparatus generates operation information related to the operation while associating the operation information with one of the classes to which properties related to the operation belong. By the operation information, the apparatus determines a positional arrangement of property columns and generates positional arrangement information indicating the positional arrangement of the property columns in which the property value of the class are arranged for each of the properties. The apparatus also generates positional arrangement information indicating the determined positional arrangement of the property columns, stores therein the generated positional arrangement information while associating it with the class, and generates display data used for displaying the property columns of the class based on the positional arrangement information.

### CROSS-REFERENCE TO RELATED APPLICATIONS

This application is based upon and claims the benefit of priority from the prior Japanese Patent Application No. 2008-333287, filed on Dec. 26, 2008; the entire contents of which are incorporated herein by reference.

### BACKGROUND OF THE INVENTION

1. Field of the Invention

The present invention relates to an apparatus, a method, and a computer product for supporting information editing.

2. Description of the Related Art

According to object-oriented methods, classes generally form a hierarchical class structure. The structure has a system in which a class inherits all properties of its superclass. Each of the classes is associated with data expressing the substance of the class. Generally speaking, each piece of data is called an instance. The minimal element of each instance is a pair made up of a property of the class and a value of the property. Each instance is expressed as data by using combinations of such pairs.

International Organization for Standardization (ISO) 13584 (i.e., Industrial Automation Systems and Integration—Parts Library [PLIB]), which is an international standard related to an electronic catalogue of industrial products and component parts, also has a data structure in which the subclasses inherit the properties from their superclasses in an object-oriented manner. In the PLIB, schemas of the classes and the properties such as “Basic Semantic Unit (BSU) code” and “preferred name” each of which is a unique ID are defined. Meta data of the classes and the properties are written according to the defined schemas. The information of the classes and the properties that is written in this manner is called a dictionary. The catalogue is written according to the dictionary.

When a user edits or browses instances of a class, a table is displayed as an interface in many situations due to its “list-view” characteristic and operability, the table including a plurality of property columns in which properties of various types are arranged respectively in such a manner that an instance, which is a corresponding property value, is arranged on each of the horizontal lines in each of the columns. In particular, the larger the number of instances that are written or browsed, the larger is the merit of the table. In such a table, each of the columns is configured so as to include a header such as an ID of the property so that the columns can be identified in a one-to-one correspondence as well as additional information such as a name of the property or a data type.

In ISO 13584 described above, an interface in a table format having a plurality of property columns is standardized in ISO/Technical Specification (TS) 13584-35, which is a part of ISO 13584. In ISO/TS 13584-35, a dictionary and instances are expressed by using one or more sheets that are made up of a header section describing meta data and schemas and a data section describing values according to the schemas. In this example, to each of the columns in the header section, at least an ID of the property is given as a header that identifies the column.

Generally speaking, in an application that displays data while using a table including a plurality of property columns as an interface, as long as the positional arrangement of the columns are not restricted physically or logically, the user is able to freely change the positional arrangement of the columns, before performing a data editing process, while performing a data editing process, and after performing a data editing process. To change the positional arrangement of the columns, the user drags and drops an entire column into a predetermined position by using a pointing device or the like. Also, in some applications, the same operation is realized when a column is “cut” and “pasted”. In a number of applications, it is possible to move a plurality of columns by performing only one operation. In relation to this, in some applications it is possible to select columns displayed in positions that are physically distant from each other. With this arrangement, because it is possible to move, as necessary, columns in which the values are directly edited and other related columns to a display area during an editing process, the user does not need to perform, for example, the operation of scrolling the screen many times. As a result, it is possible to reduce the load on the user and to expect the operation efficiency to be greatly improved.

In the case where no positional arrangement of the columns is defined physically or logically, a positional arrangement is determined by using a certain method when data that is in a permanent state in a file or in a database is read and displayed in a table including a plurality of property columns. For example, in the case where data is read from a file in a spreadsheet application, the data is displayed by using physical positional information in the file. The positional arrangement is, however, not necessarily an optimal one for the user. For example, in the case where the data is displayed in a fixed positional arrangement (e.g., a positional arrangement according to which pieces of data are displayed in ascending order of property identifiers), a problem arises where every time the data is displayed, a user needs to move referenced property columns to desired positions for the purpose of making the operation more efficient. Also, in the case where a large number of users sequentially edit data in a work flow, a state of data resulting from an editing process performed by a user is handed down to another user who is next in line in many situations. In those situations, if the properties that are directly edited and the properties that are referenced are different for different types of the users' operations, a problem arises where each user needs to rearrange the scattered properties to desired positions.

To cope with these problems, JP-A 2004-177996 (KOKAI), for example, proposes a method by which a user establishes a setting for a referenced property and a positional arrangement thereof for each of classes so that a desired positional arrangement of columns can be applied to the display of instances in each of the classes. The technique disclosed in JP-A 2004-177996 (KOKAI), however, has a problem where the larger the number of properties is, the more complicated the operation becomes. In addition, another problem is that it is difficult for a user to establish a setting that is able to improve the operation efficiency, unless the user has a good understanding of the actual specifics of the operations, because the user needs to explicitly determine a selection and a configuration of the properties. As another example, JP-A 2000-322260 (KOKAI) proposes a method by which the number of times each property has been accessed is recorded so that the properties are sequentially arranged in a descending order based on the number of times each of the properties has been accessed.

According to the technique disclosed in JP-A 2000-322260 (KOKAI), however, a focus is placed only on the accesses that have been made to each of the properties. Thus, a problem remains where, during an editing process of instances, which are the values of the properties, if there is another related property, the user needs to look for the position in which the property at a reference destination is displayed. In addition, another problem is that, because changes in the positional arrangement that are caused by a column moving operation performed by a user is not taken into account, it is difficult to provide a flexible positional arrangement in which the user's intention is taken into consideration.

### SUMMARY OF THE INVENTION

An apparatus for displaying instance data of a class in a table including a plurality of property columns includes a receiving unit configured to receive an operation performed by a user; an operation information generating unit configured to, in a case where the operation related to editing of property values or referencing of property values, generate operation information related to the operation while associating the operation information with one of the classes to which properties related to the operation belong; a positional arrangement information generating unit configured to determine by the information, a positional arrangement of property columns and to generate positional arrangement information indicating the positional arrangement of the property columns in which the property value of the class are arranged for each of the properties; an information storage unit configured to store therein the positional arrangement information while associating the same with the one of the classes; and a display data generating unit configured to generate display data used for displaying the property columns of the one of the classes, based on the positional arrangement information.

According to another aspect of the present invention, A method for displaying instance data by a display apparatus that displays the instance data of a class in a table including a plurality of property columns, wherein the apparatus comprises a an receiving unit, an operation information generating unit, a positional arrangement information generating unit, a information storage unit, and a display data generating unit, the method includes receiving, by the receiving unit, an operation performed by a user; generating, by the operation information generating unit, in a case where the operation related to editing of property values or referencing of property values, generate operation information related to the operation while associating the operation information with one of the classes to which properties related to the operation belong; determining, by the positional arrangement information generating unit, a positional arrangement of property columns by the information, generating, by the positional arrangement information generating unit, positional arrangement information indicating the positional arrangement of the property columns in which the property value of the class are arranged for each of the properties; storing, by the information storage unit, the positional arrangement information while associating the same with the one of the classes; and generating, by the display data generating unit, display data used for displaying the property columns of the one of the classes, based on the positional arrangement information.

According to another aspect of the present invention, A computer program product having a computer readable medium including programmed instructions that, when executed by a computer, cause the computer to perform displaying instance data of a class in a table including a plurality of property columns: receiving an operation performed by a user; generating, in a case where the operation related to editing of property values or referencing of property values, generate operation information related to the operation while associating the operation information with one of the classes to which properties related to the operation belong; determining, by the information, a positional arrangement of property columns; generating positional arrangement information indicating the positional arrangement of the property columns in which the property value of the class are arranged for each of the properties; storing the positional arrangement information while associating the same with the one of the classes; and generating display data used for displaying the property columns of the one of the classes, based on the positional arrangement information.

### BRIEF DESCRIPTION OF THE DRAWINGS

FIG. 1 is an exemplary hardware diagram of a client terminal 100 according to an embodiment of the present invention;

FIG. 2 is an exemplary functional diagram of the client terminal 100 according to the embodiment of the present invention;

FIG. 3 is an exemplary conceptual drawing of a hierarchical class structure in which the constituent elements are classes;

FIG. 4 is a drawing of examples of a class table 301 and a property table 302 that are stored in a dictionary storage unit 203 as dictionary information in accordance with the hierarchical structure shown in FIG. 3;

FIG. 5 is a drawing of an example of an instance table according to the embodiment of the present invention;

FIG. 6 is a drawing of an example of a display area G1 that is a part of the instance table shown in FIG. 5 and is an area to be actually displayed on a screen of a display unit 103;

FIG. 7 is a flowchart of a procedure in an operation information extracting process according to the embodiment of the present invention;

FIG. 8 is a flowchart of a detailed procedure in a process for generating operation information according to the embodiment of the present invention;

FIG. 9 is a drawing of an example of a display area G2 within the instance table of a class C03 shown in FIG. 6;

FIG. 10 is a drawing of an example of a display area G3 within the example shown in FIG. 9;

FIG. 11 is a drawing of a display area G4 within the example shown in FIG. 10;

FIG. 12 is a drawing of an example of operation information stored in an operation information storage unit 206 according to the embodiment of the present invention;

FIG. 13 is a flowchart of a procedure in a positional arrangement information generating process for generating positional arrangement information according to the embodiment of the present invention;

FIG. 14 is a drawing of examples of scores that are calculated for properties in each of processing blocks with respect to the operation information shown in FIG. 12;

FIG. 15 is a flowchart of a detailed procedure in a process for generating the positional arrangement information that is performed at Step S1206 according to the embodiment of the present invention;

FIG. 16 is a drawing of an example of positional arrangement information for the class C03 shown in FIG. 14; and

FIG. 17 is an exemplary functional diagram of the client terminal 100 according to a modification example of the embodiment of the present invention.

### DETAILED DESCRIPTION OF THE INVENTION

Exemplary embodiments of an apparatus, a method, and a computer program for displaying instance data according to the present invention will be explained in detail, with reference to the accompanying drawings.

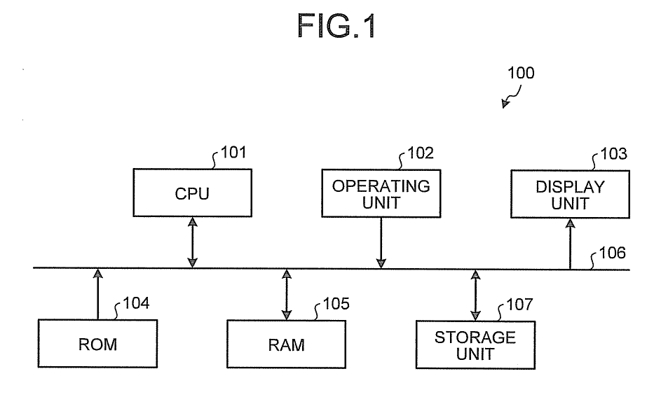

First, a hardware configuration of an apparatus for display according to an embodiment of the present invention will be explained. FIG. 1 is an exemplary hardware diagram of the client terminal 100 that functions as the apparatus for display according to the present embodiment. The client terminal 100 includes a controlling unit 101 such as a Central Processing Unit (CPU) that controls the entire apparatus; storage units such as a Read-Only Memory (ROM) 104 and a Random Access Memory (RAM) 105 that store therein various types of data and/or various types of computer programs; an external storage unit 107 such as a Hard Disk Drive (HDD) and/or a Compact Disk (CD) drive device that stores therein various types of data and/or various types of computer programs; and a bus 108 that connects these constituent elements to one another. The client terminal 100 has a hardware configuration to which a commonly-used computer can be applied. Further, a display unit 103 that displays information, an input unit 102 such as a keyboard and/or a mouse that receives an input of an instruction from a user, and a communication interface (I/F) that controls communication with external apparatuses are connected to the client terminal 100 with a wired or wireless network.

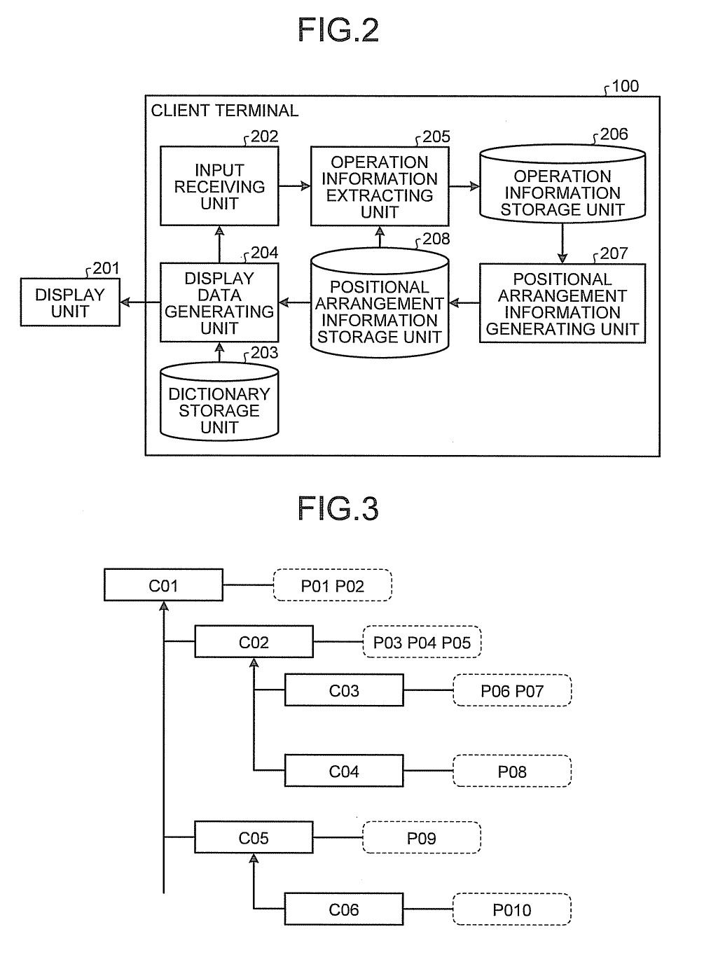

Next, various types of functions that are realized when, in the hardware configuration described above, the CPU of the client terminal 100 executes the various types of computer programs that are stored in the storage devices or the external storage devices will be specifically explained. As shown in FIG. 2, the client terminal 100 includes a receiving unit 202, a dictionary storage unit 203, a display data generating unit 204, an operation information extracting unit 205, an operation information storage unit 206, a positional arrangement information generating unit 207, and an information storage unit 208. Of these constituent elements, the receiving unit 202, the display data generating unit 204, the operation information extracting unit 205, and the positional arrangement information generating unit 207 are loaded in a storage unit such as the RAM 105 when the controlling unit 101 executes the computer programs. The dictionary storage unit 203, the operation information storage unit 206, and the information storage unit 208 are stored in, for example, the external storage unit 107.

The dictionary storage unit 203 has information about the structure including the above-described classes as the constituent elements and stores therein dictionary information that identifiably indicates hierarchical levels of the classes and one or more properties of each of the classes. More specifically, the dictionary information includes: a class table that shows, at least, parent-child relationships among the classes as information; and a property table that shows information regarding one or more properties of each of the classes while associating the properties with the classes, the properties not being properties of the superclasses of those classes at the same time. A class ID that identifies a class in a one-to-one correspondence is assigned to each of the classes. A property ID that identifies a property in a one-to-one correspondence is assigned to each of the properties.

In object oriented method, a class can inherit all properties from another class. Such a relationships between classes is called “parent-child relationship”. Generally, a parent class is called “superclass” and a child class is called “subclass”. Here, the superclass of the superclass the class is also a superclass of the class. To distinguish the superclass which is directly linked to a class from the other superclasses of the class, the former is called “direct superclass” in this document. Needless to say, these rules are also applied to subclass relationship.

As shown in FIG. 3, class IDs C01 to C06 are assigned to the classes, respectively. It is indicated that a hierarchical class structure is formed with six classes that are namely the classes C01 to C06. The classes are connected to one another by using solid-line arrows each of which points at its direct superclass. In the example in FIG. 3, one to three properties are defined for each of the classes and are used immediately. For example, for the class C01, two properties P01 and P02 are defined and have started being used immediately. Similarly, for the class C02, three properties P03, P04, and P05 are defined and have started being used immediately. According to an object-oriented method, each of subclasses inherits the properties from a superclass thereof. For example, the class C02 inherits the properties P01 and P02 from the class C01. Similarly, the class C03 inherits the properties P01 to P05 from the class C02.

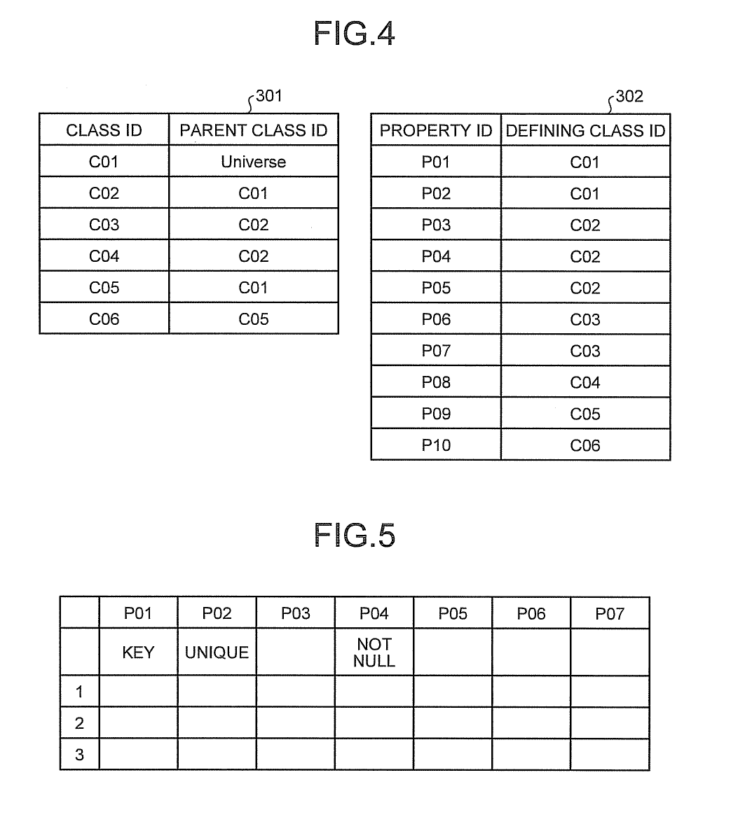

As shown in FIG. 4, the class table 301 stores therein, for each of the classes, the class ID of the class and the class ID of the parent class thereof, which is the immediately superorclass, while associating them with each other. The property table 302 stores therein, for each of the properties, the property ID of the property and the class ID of the class that defines the property and starts using the property, while associating them with each other. In the example shown in FIG. 4, the properties that are inherited from any superclass are omitted from the property table 302; however, it is possible to identify the inherited properties by referring to the parent-child relationships s among the classes shown in the class table 301 and the property table 302. For example, it is possible to identify that the properties of the class CO2 are the properties P03 to P05 by referring to the property table 302 and that the parent class of the class C02 is the class C01 by referring to the class table 301. Further, it is also possible to identify that the properties of the class C01 are the properties P01 and P02 by referring to the property table 302. Accordingly, it is possible to identify that the properties of the class C02 are the properties P01 to P05. In this manner, by referring to the class table 301 and the property table 302, it is possible to completely identify the hierarchical structure shown in FIG. 3.

Returning to the explanation with reference to FIG. 2, the receiving unit 202 receives an input of any of various types of operations via an input device. Also, the receiving unit 202 receives an input specifying a class that is an operation target via an input device. The operation information extracting unit 205 extracts specifics of any of the various types of operations that has been received as the input by the receiving unit 202 and generates operation information with regard to the properties that are related to a predetermined type of operation. The operation information extracting unit 205 further stores the generated operation information into the operation information storage unit 206, while associating the operation information with the class ID of the class that is the operation target. The predetermined type of operation is an operation related to at least one of the following operations: an operation to edit a value of a property (hereinafter, a “property value”); and an operation to reference a property value. The operation information storage unit 206 stores therein the operation information that has been generated by the operation information extracting unit 205 while associating the operation information with the class that is the operation target. The predetermined type of operation and the details of the operation information will be explained in the sections below where operational functions are described. By using the operation information stored in the operation information storage unit 206, the positional arrangement information generating unit 207 determines a positional arrangement of property columns in which the property values of the operation target class are arranged for each of different properties, according to the operation that can be performed as the user's operation, which is at least one of an operation to edit a property value and an operation to reference to a property value. The positional arrangement information generating unit 207 further generates positional arrangement information that indicates the determined positional arrangement and stores the generated positional arrangement information into the information storage unit 208, while associating the positional arrangement information with the class that is the operation target. The information storage unit 208 stores therein the positional arrangement information that has been generated by the positional arrangement information generating unit 207, while associating the positional arrangement information with the class that is the operation target.

To cause the display unit 103 to display property columns of the properties of an operation target class, the display data generating unit 204 determines a positional arrangement of the property columns of the class, based on whether the positional arrangement information of the class has already been stored in the information storage unit 208. Further, by using the dictionary information stored in the dictionary storage unit 203, the display data generating unit 204 generates display data used for causing the display unit 103 to display all or a part of the property columns of the class including or not including its instances (i.e., the set of property values) according to the determined positional arrangement. More specifically, in the case where the positional arrangement information of the class has already been stored in the information storage unit 208, the display data generating unit 204 determines the positional arrangement indicated by the stored positional arrangement information as a positional arrangement of the property columns to be displayed. In the case where the positional arrangement information of the class has not yet been stored in the information storage unit 208, the display data generating unit 204 determines a positional arrangement of the property columns to be displayed by using a predetermined method or an arbitrary method. After that, the display data generating unit 204 generates the display data used for causing the display unit 103 to display the property columns according to the positional arrangement that has been determined in either one of the situations. More specifically, to generate the display data, the display data generating unit 204 generates an instance table showing the properties of the class as table header items and the instances, by using the dictionary information stored in the dictionary storage unit 203 and generates the display data used for causing the display unit 103 to display the part or all of the property columns that are shown in the generated instance table.

In FIG. 5, an instance table that is used for editing the instances of the class C03 while the class C03 shown in FIG. 3 is used as an operation target is shown. As shown in FIG. 5, the properties P01 to P07 of the class C03 are sequentially arranged in the columns. Also, as shown in FIG. 5, in the case where a cell into which a property value can be input is blank, the value is interpreted as “NULL”. In the explanation below, the columns that respectively correspond to the properties and in which a property value is to be shown on each line, as shown in FIG. 5, will be referred to as the “property columns”.

As items in the property columns, the instance table may be configured so as to include, implicitly or explicitly, meta data that is used by human users or computers, in addition to the property IDs that are used for identifying the property columns. For example, in the example shown in FIG. 5, information for a table-control purpose that is commonly used in relational databases is shown on line 2 as headers. Examples of such table-control purpose information include a “KEY” keyword (i.e., key information), a “UNIQUE” keyword (a uniqueness constraint), and a “NOT NULL” keyword (i.e., a “NOT NULL” constraint). The “KEY” keyword defines a property used for identifying an instance written on a line. It is possible to set a plurality of “KEY” properties in each instance table. The “UNIQUE” keyword defines that none of the values of the property to which the “UNIQUE” keyword has been set duplicate any other instances, which are the values on the other lines of the property. The “NOT NULL” keyword defines, for each of the instances, that the value of the property to which the “NOT NULL” keyword has been set is requisite. The types and the usage of the keywords written for the table-control purpose are not limited to these examples. It is acceptable to write any other types of table-control purpose information. Further, it is also acceptable to configure the instance table to show any other various types of information in addition to the table-control purpose information. In the client terminal 100 according to the present embodiment, how the information shown in the instance table is managed is not limited. For example, the information may be directly set in each individual file. Alternatively, the information may be registered in a server or the like so that the information can be shared among a plurality of applications. Further, another arrangement is acceptable in which a subclass refers to and use information that has been set for a superclass, by making use of the inheritance relationship between the classes.

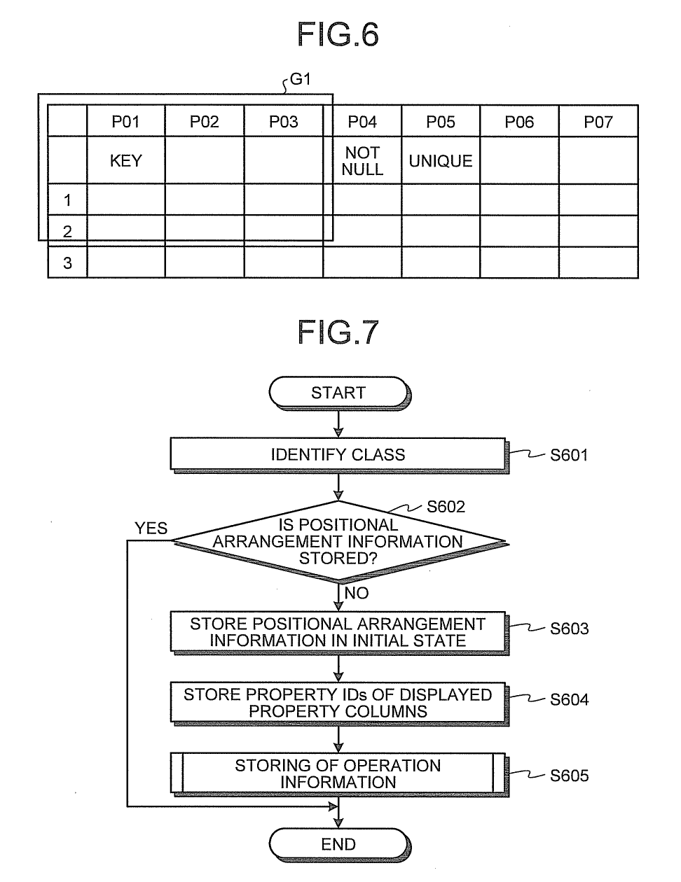

FIG. 6 is a drawing of an example of a display area G1, which is a part of the instance table shown in FIG. 5 and is an area that is actually displayed on a screen of the display unit 103. In the present example, it is indicated that, of the property columns shown in the instance table, the properties P01 to P03 are displayed at the same time as the display area G1 on one screen. The present example is an example that is displayed on the screen according to the display data generated by the display data generating unit 204 for displaying the property columns in ascending order of the property IDs as shown in FIG. 6 in the situation where no positional arrangement information of the class C03 is stored in the information storage unit 208. Also, in the present example, it is indicated that no information other than the headers including the property IDs and the table-control purpose information is displayed, because no instance has been registered.

Next, a procedure in a process performed by the client terminal 100 according to the present embodiment will be explained. According to the present embodiment, an example will be explained in which the display unit 103 is caused to display a part of the property columns shown in the instance table of the class C03 shown in FIG. 5 so that a user can perform an operation to edit the instances. In this situation, first, the class C03 is specified as the class that is an operation target, via the input device. When having received the input that specifies the class C03 as the operation target, the client terminal 100 uses a function of the display data generating unit 204 and generates display data for causing the display unit 103 to display a part of the property columns shown in the instance table of the class C03 by using the dictionary information stored in the dictionary storage unit 203 so that the display unit 103 is caused to display the part of the property columns shown in the instance table of the class C03. The client terminal 100 then loads the generated display data into a storage device. In this situation, the client terminal 100 performs an operation information extracting process to generate operation information and also performs a positional arrangement information generating process to generate positional arrangement information by using the generated operation information. After that, when the client terminal 100 again causes the display unit 103 to display a part of the property columns shown in the instance table of the class C03 in another occasion, it is possible to realize a display in which the positional arrangement information that has been generated in the positional arrangement information generating process is used.

First, a procedure in the operation information extracting process will be explained, with reference to FIG. 7. The client terminal 100 uses a function of the operation information extracting unit 205 and checks to see if positional arrangement information that is associated with the class C03 has already been stored in the information storage unit 208 (Step S601). In the case where no positional arrangement information that is associated with the class C03 is stored (Step S602: No), the client terminal 100 continues the process, and the process proceeds to Step S603. Let us continue the explanation on the assumption that no positional arrangement information that is associated with the class C03 is stored in the information storage unit 208. Conversely, in the case where the positional arrangement information that is associated with the class C03 is stored (Step S602: Yes), the client terminal 100 ends the process. In this situation, the client terminal 100 generates display data used for causing the display unit 103 to display a part of the property columns shown in the instance table of the class C03 according to the positional arrangement indicated by the positional arrangement information that is associated with the class C03 and loads the generated display data into a storage device.

At Step S603, when the client terminal 100 has loaded, by using the function of the display data generating unit 204, the display data used for displaying the part of the property columns shown in the instance table of the class C03, the client terminal 100 uses a function of the positional arrangement information generating unit 207 and generates positional arrangement information indicating a positional arrangement of the property columns at that point in time. The client terminal 100 then stores the generated positional arrangement information into the information storage unit 208. Further, the client terminal 100 extracts the display area displayed on the display unit 103 at the point in time when the display data has been loaded and stores the property IDs that correspond to the property columns displayed in the display area into a storage device such as the RAM (Step S604).

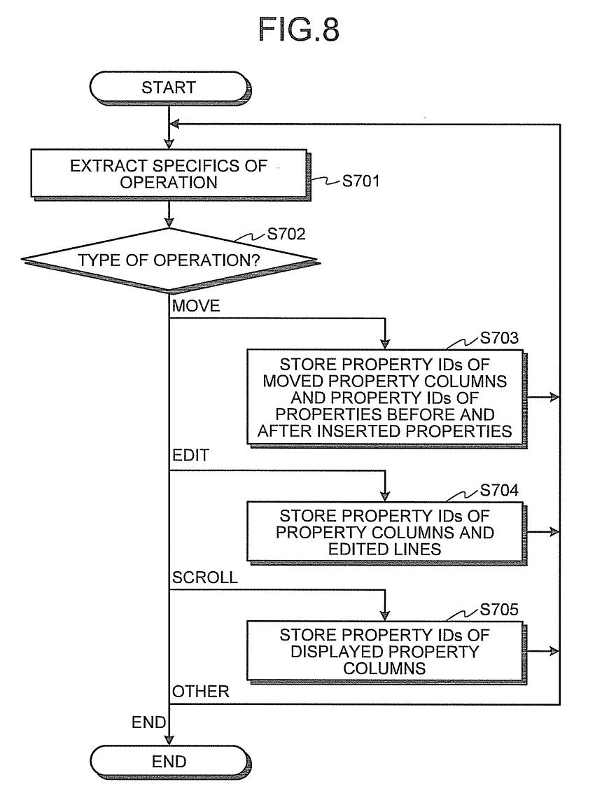

Next, the client terminal 100 uses a function of the operation information extracting unit 205 and generates operation information indicating an operation with regard to a predetermined type of operation among various types of operations that are performed when the user edits the instances on the display unit 103. The client terminal 100 then stores the generated operation information into the operation information storage unit 206 (Step S605). FIG. 8 is a flowchart of a detailed procedure in the process for generating the operation information. When the user has performed, via the input device, any of the various types of operations on a part of the property columns shown in the instance table displayed on the display unit 103, the client terminal 100 uses a function of the receiving unit 202 and receives the input of the operation and further uses a function of the operation information extracting unit 205 and extracts specifics of the operation (Step S701). The client terminal 100 then determines the type of operation (Step S702). In this situation, the client terminal 100 judges whether the type of operation is a predetermined type of operation. Examples of the predetermined type of operation include an operation to edit one or more property values, which is an operation related to editing of property values as explained below, as well as an operation to move one or more property columns and an operation to change the display area, which are operations related to referencing of the property values.

In the case where the type of operation is an operation to move one or more property column (Step S702: move), in other words, in the case where one or more property columns are moved so as to be inserted between other property columns so that the positional arrangement thereof is changed, the client terminal 100 performs the following process. The client terminal 100 generates operation information indicating a sequence of property IDs of all the property columns that have been moved; the property IDs of the property columns that are positioned before and after the inserted property columns; and the property IDs of the property columns that are displayed on the display unit 103 after the moving process has been performed. The client terminal 100 then stores the generated operation information into the operation information storage unit 206 while associating the operation information with the class C03, which is the operation target (Step S703). After that, the client terminal 100 suspends until a next operation is input. In the case where it is possible to identify the position in which the one or more property columns are inserted, another arrangement is acceptable in which, with regard to the property columns that are positioned before and after the inserted property columns, the client terminal 100 generates operation information that indicates the property ID of only one of the property columns that are positioned before and after the inserted property columns, but not the property IDs of both of those property columns.

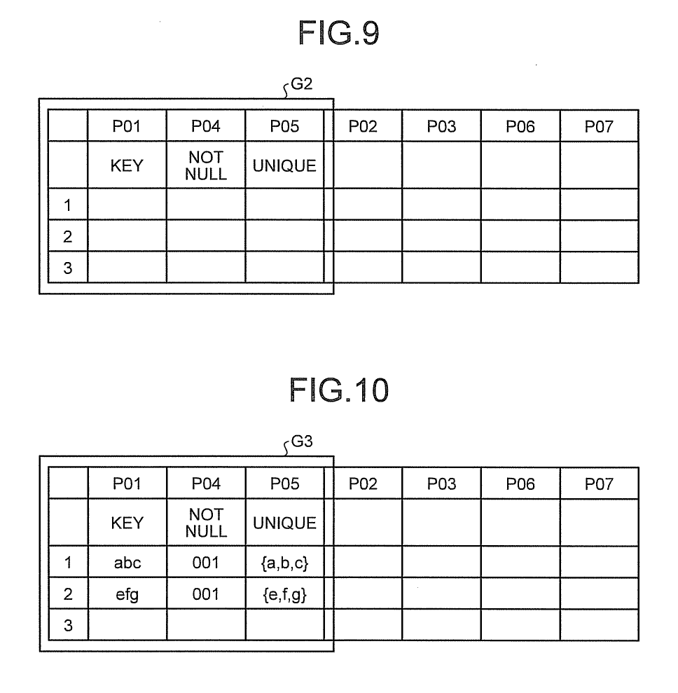

FIG. 9 is a drawing of an example of a display area G2 that is obtained when the two property columns for the properties P04 and P05 have been moved to a position between the property columns for the properties P01 and P02 within the instance table of the class C03 shown in FIG. 6. In the example shown in FIG. 9, because the property columns for the properties P04 and P05 have been moved, the property columns in the display area G2 displayed on the display unit 103 are the property columns for the properties P01, P04, and P05. In this situation, at Step S703, the client terminal 100 generates operation information indicating the property IDs P04 and P05 as a sequence of property IDs of all the property columns that have been moved; the property IDs P01 and P02 as the property IDs of the property columns that are positioned immediately before and after the inserted property columns for the properties P04 and P05; and the property IDs P01, P04, P05 as the property IDs of the property columns that are displayed on the display unit 103 after the moving process has been performed. The client terminal 100 then stores the generated operation information into the operation information storage unit 206 while associating the operation information with the class C03, which is the operation target.

As another example, in the case where the type of operation is an operation to edit one or more property values (Step S702: edit), the client terminal 100 extracts the property IDs of the properties of which the values have been edited and generates operation information indicating the extracted property IDs and the lines on which the edited values are positioned. The client terminal 100 then stores the generated operation information into the operation information storage unit 206 while associating the operation information with the class C03, which is the operation target (Step S704). After that, the client terminal 100 stands by until a next operation is input.

FIG. 10 is a drawing of an example of a display area G3 that is obtained when the property values on lines 1 and 2 for the properties P01, P04, and P05 have been edited in the example shown in FIG. 9. In FIG. 10, the edited values are shown on lines 1 and 2 for each of the properties P01, P04, and P05. In this situation, at Step S704, the client terminal 100 extracts the property IDs P01, P04, and P05 as the property IDs of the properties of which the values have been edited and generates operation information indicating the extracted property IDs P01, P04, and P05 and “line 1” and “line 2”, which are the lines on which the edited property values are positioned. The client terminal 100 then stores the generated operation information into the operation information storage unit 206 while associating the operation information with the class C03, which is the operation target.

As yet another example, in the case where the type of operation is an operation to change the display area of the property columns (Step S702: scroll), in other words, in the case where the type of operation is an operation to change the display-target property columns by performing a scrolling operation in the horizontal direction of the instance table, the client terminal 100 performs the following process. The client terminal 100 extracts a sequence of property IDs of the property columns displayed on the display unit 103 after the scrolling process has been performed and generates operation information indicating the extracted property IDs. The client terminal 100 then stores the generated operation information into the operation information storage unit 206, while associating the operation information with the class C03, which is the operation target (Step S705). After that, the client terminal 100 stands by until a next operation is input.

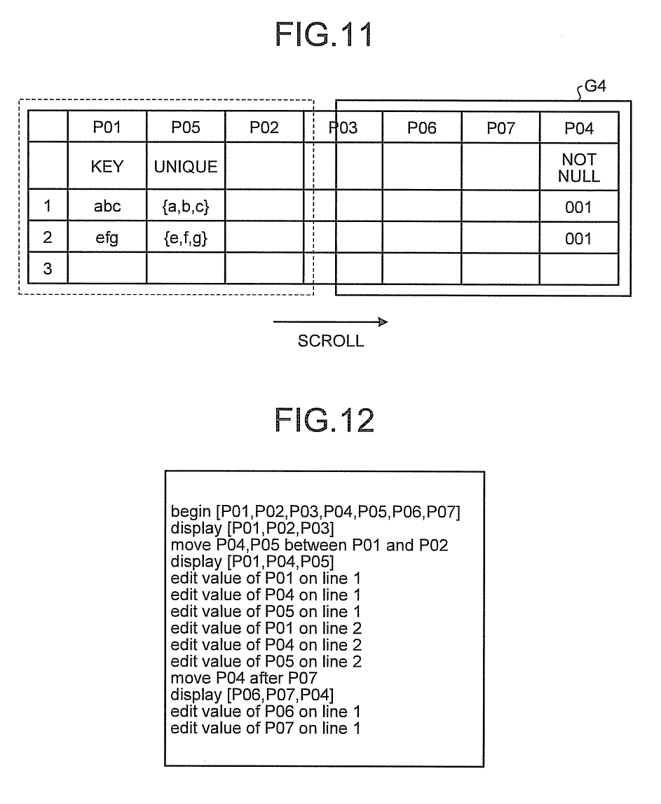

FIG. 11 is a drawing of a display area G4 that is obtained when the property column for the property P04 has been moved to a position immediately after the property column for the property P07 within the example shown in FIG. 10, and the display area is changed by a scrolling operation in the horizontal direction so that the property columns for the properties P06, P07, and P04 can be displayed, and further, the property values on line 1 for the properties P06 and P07 have been edited. In this situation, the process at Step S703 corresponding to “move”, the process at Step S704 corresponding to “edit”, and the process at Step S705 corresponding to “scroll” are all performed at Step S702. In this situation, at Step S703, the client terminal 100 generates operation information indicating the property ID P04 as a sequence of property IDs of all the property columns that have been moved; the property ID P07 as the property ID of the property column that is positioned immediately before the inserted property P04; and the property IDs P01, P05, and P03 as the property IDs of the property columns that are displayed on the display unit 103 after the moving process has been performed. The client terminal 100 then stores the generated operation information into the operation information storage unit 206, while associating the operation information with the class C03, which is the operation target. At Step S704, the client terminal 100 extracts the property IDs P06 and P07 as the property IDs of the properties of which the values have been edited and generates operation information indicating the extracted property IDs P06 and P07 and “line 1” and “line 2”, which are the lines on which the property values have been edited. The client terminal 100 then stores the generated operation information into the operation information storage unit 206, while associating the operation information with the class C03, which is the operation target. Further, at Step S705, the client terminal 100 extracts the property IDs P06, P07, and P04 as a sequence of property IDs of the property columns displayed on the display unit 103 after the scrolling process has been performed and generates operation information indicating the extracted property IDs P06, P07, and P04. The client terminal 100 then stores the generated operation information into the operation information storage unit 206, while associating the operation information with the class C03, which is the operation target. Because these operations are performed as a series of operations, the client terminal 100 generates these three pieces of operation information as one piece of data and stores the one piece of data into the operation information storage unit 206, while associating the data with the class C03.

As yet another example, in the case where the type of operation is an operation to end an editing operation (Step S702: end), the client terminal 100 ends the operation information extracting process. As yet another example, in the case where the type of operation is an operation other than the examples of operations described above (i.e., the operations to move, edit, scroll, and end) (Step S702: other), the client terminal 100 stands by until a next operation is input.

In addition to the operations to move, edit, scroll, and end, it is acceptable to include an editing operation according to, for example, a method (e.g., a check button) for explicitly indicate a transition of a display area or whether the user is referencing the data. For example, a transition of a display area is realized when a “search” function to search for a value among pieces of data in a table format is used so that a focus is automatically moved to an area in which the searched data is detected and the focused location is displayed. Further, it is also acceptable to perform the operation information extracting process in the same manner in the case where a check button used for checking to see whether data is referenced is introduced in consideration of a situation in which a wrong cell is referenced by the search function.

FIG. 12 is a drawing of an example of operation information stored in the operation information storage unit 206. The operation information shown in FIG. 12 has been generated according to the operations performed by the user on the instance table of the class C03 shown in FIG. 5. The operations are the series of operations shown in FIGS. 9 to 11. Thus, the operation information related to these operations has been generated as one piece of data. In the operation information shown in FIG. 12, each of the operations of which the specifics have been extracted by the operation information extracting unit 205 is shown on a different one of the lines. For example, on line 1 starting with “begin”, the sequence of property IDs of the properties in the initial state is shown. On line 2 starting with “display”, the sequence of property IDs of the properties that are in the display area is shown in relation to the display. On line 3 starting with “move”, the property IDs of the property columns to be moved and the property IDs of the property columns that are positioned immediately, before and after the inserted properties are shown in relation to the moving operation. On each of the lines starting with “edit”, a property ID of a different one of the properties of which the instances are edited as well as the line on which the value is edited are shown in relation to the editing operation.

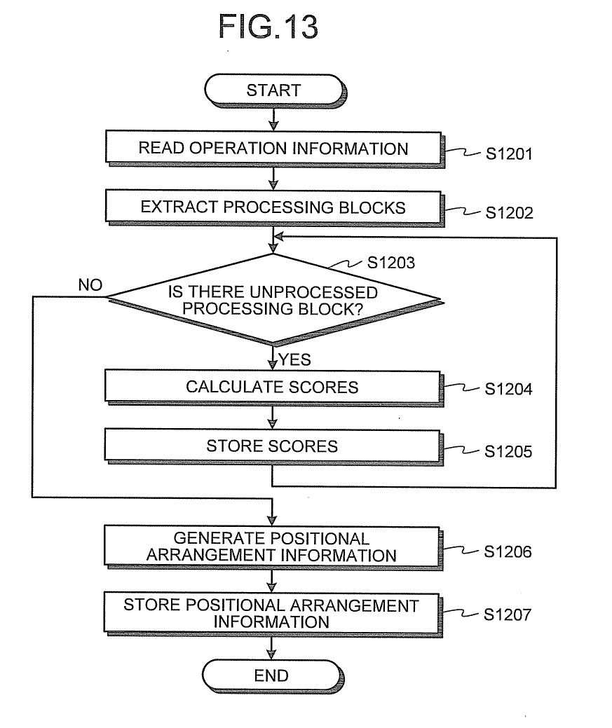

Next, a procedure in a positional arrangement information generating process to generate positional arrangement information by using the operation information that has been generated in the manner described above and has been stored in the operation information storage unit 206 while being associated with the class C03, which is the operation target, will be explained, with reference to FIG. 13. First, the client terminal 100 uses a function of the positional arrangement information generating unit 207 and reads the operation information that has been stored in the operation information storage unit 206 associated with the class that has been specified as an operation target by the user via the input device (Step S1201). For example, in the case where the class C03 has been specified as an operation target, the operation information that is shown in FIG. 12 and is explained above is read.

Next, the client terminal 100 extracts, from respect to the read operation information, processing blocks while using an operation to move one or more property columns as one basic unit (Step S1202). In the case where two or more operations to move property columns are performed in series, the client terminal 100 performs the process while regarding the series of moving operations as one unit.

Next, for each of the extracted processing blocks, the client terminal 100 performs a score calculating process to calculate scores of the properties according to at least one of a property value editing process and a property value referencing process that can have been performed in conjunction with each property column moving process. More specifically, in the case where there is at least one processing block for which the score calculating process has not yet been performed (Step S1203: Yes), the client terminal 100 performs the score calculating process on the processing block (Step S1204). In the score calculating process, the client terminal 100 calculates, depending on frequency of editing processes and referencing processes that have been performed, the scores for the properties of which the values have been edited and for the properties of which the values is assumed to have been referenced during the editing processes (i.e., the properties that are in the property columns displayed on the screen of the display unit 103 before the editing process has been performed, as a result of property-column moving processes and/or screen scrolling processes). The client terminal 100 then stores the scores that have been calculated for the properties into a storage device such as the RAM (Step S1205).

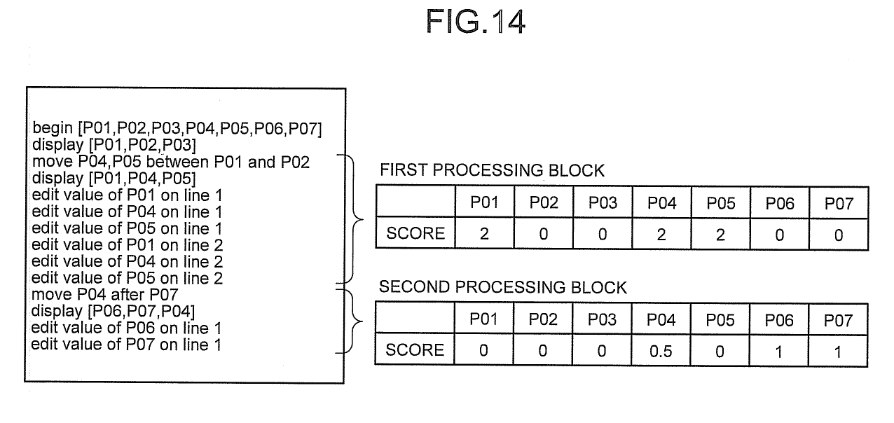

FIG. 14 is a drawing of examples of the scores that are calculated for the properties in each of the processing blocks with respect to the operation information shown in FIG. 12. In the present example, scores are applied when the scores are calculated. More specifically, when the value of a property has been edited, a score “1” is applied to the property. When the value of a property has been referenced but has not been edited, a score “0.5” is applied to the property. A first processing block that is extracted first corresponds to the lines from line 3 starting with “move” up to line 8 starting with “edit”. In the first processing block, while the properties P01, P04, and P05 are being displayed on the screen, the value of each of these properties has been edited twice. Thus, the score of each of these properties is calculated as “2”. A second processing block that is extracted second corresponds to the lines from line 9 starting with “move” up to line 12 starting with “edit”. In the second processing block, while the properties P06, P07, and P04 are being displayed on the screen, the value of the property P06 and the value of the property P07 have each been edited once. Thus, the score of each of the properties P06 and P07 is calculated as “1”. As for the property P04, the value thereof has not been edited, but the value thereof is assumed to have been referenced while being displayed on the screen of the display unit 103 as a result of the moving process. Thus, the score of the property P04 is calculated as “0.5”.

When the score calculating process has been performed in this manner on all the processing blocks (Step S1203: No), the client terminal 100 subsequently generates positional arrangement information in the manner described below (Step S1206).

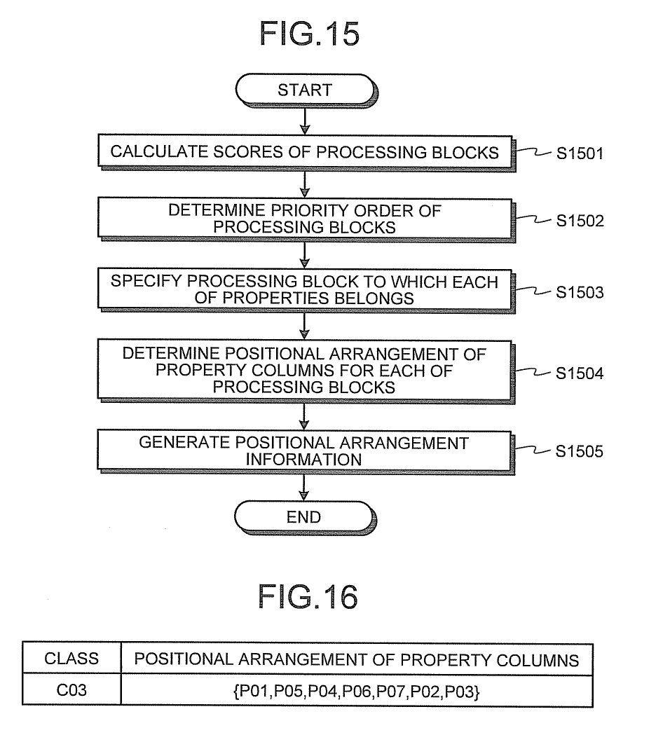

FIG. 15 is a flowchart of a detailed procedure in the process for generating the positional arrangement information that is performed at Step S1206. First, for each the processing blocks, the client terminal 100 selects the highest score among the scores of the properties that have been calculated and stored in the score calculating process and stores the selected highest score into, for example, a storage device as the score of the processing block (Step S1501). Subsequently, by referring to the scores of the processing blocks, the client terminal 100 determines the priority order of the processing blocks so that a higher priority is given to a processing block having a higher score (Step S1502). After that, for each of the properties, the client terminal 100 refers to the score in each of the processing blocks and specifies the processing block having the highest score as the property block to which the property belongs (Step S1503). Lastly, for each of the processing blocks, the client terminal 100 determines a positional arrangement of the property columns, according to the scores of the properties that belong to the processing block (Step S1504). After that, the client terminal 100 generates positional arrangement information indicating the positional arrangement of the property columns that has been determined at Step S1504 (Step S1505).

Returning to the explanation with reference to FIG. 13, the client terminal 100 subsequently stores the positional arrangement information that has been generated at Step S1505 shown at Step S1206 into the information storage unit 208, while associating the positional arrangement information with the class that is the operation target (Step S1207).

FIG. 16 is a drawing of an example of the positional arrangement information for the class C03 shown in FIG. 14. As shown in FIG. 14, for the class C03, the score of the first processing block is calculated as “2”, whereas the score of the second processing block is calculated as “1”, at Step S1501. Accordingly, at Step S1502, the stated order is determined as the priority order of these processing blocks. After that, at Step S1503, for the property P01 and the property P05, the first processing block is determined as the processing block to which each of these properties belongs. For the property P06 and the property P07, the second processing block is determined as the processing block to which each of these properties belongs. For the property P04, either the first processing block or the second processing block may be determined as the processing block to which the property belongs; however, in the present example, the first processing block having a higher score is determined as the processing block to which the property P04 belongs, so that the property P04 will be displayed in a position close to the second processing block. As for the property P02 and the property P03, since these properties do not belong to any processing block, a positional arrangement thereof is determined so that these property columns are positioned at the end. Accordingly, for the class C03, the positional arrangement of the property columns has been determined so that the properties are arranged in the following order: P01, P05, P04, P06, P07, P02, and P03. The positional arrangement information indicating this positional arrangement is stored into the information storage unit 208 while being associated with the class C03, which is the operation target.

When the positional arrangement information has been stored into the information storage unit 208 while being associated with the class C03, which is the operation target, in the manner described above, if the class C03 is specified again as an operation target so that a part of the property columns of the class C03 is to be displayed again on the display unit 103 in another occasion, the result of the judging process performed at Step S602 will be in the affirmative during the operation information extracting process shown in FIG. 7. In this situation, the client terminal 100 generates display data used for causing the display unit 103 to display the part of the property columns shown in the instance table according to the positional arrangement indicated by the positional arrangement information that is associated with the class C03 and loads the generated display data into a storage device. As a result, it is possible to display the part of property columns shown in the instance table of the class C03 according to the positional arrangement that is compliant with the specifics of the user's operations and the user's preference based on the actual editing operations performed by the user. In other words, the properties are displayed according to the positional arrangement that is optimal for the user to edit the instances.

With the arrangements described above, it is possible to automatically set the positional arrangement of the property columns, which has manually been set in the conventional example. It is possible to greatly reduce the load on the user during the positional arrangement setting process, especially when the number of properties is large.

In addition, when the conventional method by which the positional arrangement of the property columns is manually set is used, a problem remains where the result of the positional arrangement setting process is not necessarily suitable for the actual operations performed by the user. In contrast, when the configurations according to the present embodiment are used, the positional arrangement of the property columns is determined based on the actual operations performed by the user. Thus, it is possible to display the properties of an optimal positional arrangement without the user's being conscious.

Further, when the conventional method by which the positional arrangement of the property columns is manually set is used, another problem remains where it is difficult for a user who has only a little experience in editing operations to establish an accurate setting. In contrast, when the configurations according to the present embodiment are used, users who perform mutually the same editing operation are able to share the operation information. Thus, it is possible to generate a display state that is suitable for the specifics of the editing operation, based on the operation information from experienced users that is highly reliable. Consequently, it is possible for the users having only a little experience to improve efficiency in their editing operations and to learn know-how from other users.

Furthermore, when the conventional method by which the positional arrangement of the property columns is set according to how many times each of the properties has been accessed is used, a problem remains where the properties being related to one another are not necessarily displayed in the positions close to one another during a process to edit the instances (i.e., the property values). In contrast, when the configurations according to the present embodiment are used, it is possible to display the property columns according to a positional arrangement in which the properties having a higher possibility of being referenced during an editing process are taken into account, because the display state during the property value editing process is taken into consideration. As a result, the user is able to easily reference the property values related to the properties that are the editing targets.

As explained above, according to the present embodiment, it is possible to display the property columns according to the positional arrangement that is optimal for the specifics of the operations and the user's preference without forcing the user to establish any special settings. Thus, it is possible to provide an editing environment having high efficiency. Consequently, it is possible to effectively support the user's operation to edit the instance data in which the instances of the class having the properties are displayed in a plurality of property columns.

The present invention is not limited to the exemplary embodiments described above. At the implementation stage of the invention, it is possible to materialize the present invention while applying modifications to the constituent elements thereof without departing from the gist thereof. In addition, it is possible to form various inventions by combining, as necessary, two or more of the constituent elements disclosed in the exemplary embodiments. For example, it is acceptable to omit some of the constituent elements described in the exemplary embodiments. Further, it is acceptable to combine, as necessary, the constituent elements from mutually different ones of the exemplary embodiments. Furthermore, it is acceptable to apply various types of modifications as described below.

In the exemplary embodiments described above, an arrangement is acceptable in which the various types of computer programs executed by the client terminal 100 are stored in a computer connected to a network like the Internet, so that the computer programs are provided as being downloaded via the network. Another arrangement is also acceptable in which the various types of computer programs are provided as being recorded on a computer-readable recording medium such as a Compact Disk Read-Only Memory (CD-ROM), a flexible disk (FD), a Compact Disk Recordable (CD-R), a Digital Versatile Disk (DVD), in a file that is in an installable format or in an executable format.

In the exemplary embodiments described above, the client terminal 100 is used in the explanation as an example that functions as an apparatus for display; however, the present invention is not limited to this example. It is acceptable to materialize the present invention in the form of a server client system. In this situation, all or a part of the functions of the client terminal 100 described above is realized on the server side, so that the functions of the client terminal 100 described above are realized when, for example, the client terminal 100 communicates with a server via a web browser. For example, an arrangement is acceptable in which the dictionary storage unit 203 is not included in the client terminal 100 but in a server.

In the exemplary embodiments described above, the hierarchical class structure of the dictionary storage unit 203 is indicated as a simple tree in FIG. 3; however, the present invention is not limited to this example. The dictionary storage unit 203 may have any of various hierarchical structures such as a “multiple inheritance” structure in which a class has a plurality of parent classes and a “partial inheritance” structure that is formed by relationships in which a number of properties are exported, but not by parent-child relationships in a strict sense.

As another example in which a special hierarchical structure is formed, the dictionary storage unit 203 may have a flat structure that has no hierarchical levels. In other words, the dictionary storage unit 203 may have a structure in which none of the classes is a subclass of another class, so that each of the classes has only the properties defined by itself.

In the exemplary embodiments described above, the class table 301 is configured in such a manner that the hierarchical structure is expressed by defining the parent-child relationships; however, the present invention is not limited to this example. Another arrangement is acceptable in which the class table 301 is configured in such a manner that the hierarchical structure is expressed by defining the child-grandchild relationships over a plurality of generations.

In the exemplary embodiments described above, the class table 301 and the property table 302 are shown in FIG. 4 as examples of the dictionary information expressing the hierarchical structure shown in FIG. 3; however, the exemplary embodiments are not limited to these examples. It is acceptable to configure the dictionary information to include information indicating the names and the definitions of the classes and/or the properties. It is also acceptable to use the dictionary information to display and/or control such information.

Yet another arrangement is acceptable in which groups are formed in relation to the properties so that the dictionary information further indicates a group to which each of the properties belongs. In this situation, the client terminal 100 may determine a positional arrangement of the property columns by using the operation information and the groups to which the properties belong.

In the exemplary embodiments described above, in the case where no positional arrangement information of the class that is the operation target is stored in the information storage unit 208, the display data generating unit 204 determines a positional arrangement of the property columns of the class by using a predetermined method or an arbitrary method. However, another arrangement is acceptable in which, even if no positional arrangement information of the class is stored in the information storage unit 208, if positional arrangement information of a superclass thereof is stored, the display data generating unit 204 uses the positional arrangement information of the superclass as the positional arrangement information of the class that is the operation target. Yet another arrangement is acceptable in which the positional arrangement indicated by the positional arrangement information of the superclass is used as a positional arrangement of the property columns shown in an instance table in an initial state.

In the exemplary embodiments described above, a format of the operation information is shown in FIG. 12. However, the format of the operation information is not limited to this example. There is no limitation to the format of the operation information as long as the operation information is computer-readable. Further, the operation information may store therein information other than the information described above, such as comment data.

In the exemplary embodiments described above, in the case where the type of operation is an operation to edit one or more property values, the client terminal 100 generates the operation information including the property IDs of the properties of which the values have been edited and the lines on which the edited values are positioned; however, another arrangement is acceptable in which the client terminal 100 generates operation information that does not include the lines on which the edited values are positioned.

Further, yet another arrangement is acceptable in which a plurality of pieces of operation information are present for each of the classes. In other words, the operation information storage unit 206 may store therein mutually different pieces of operation information for each of the classes.

In the exemplary embodiments described above, at Step S1501 where the score of each of the processing blocks is calculated, the client terminal 100 selects the highest score among the properties' scores as the score of the processing block; however, the present invention is not limited to this example. Another arrangement is acceptable in which a sum of the scores of the properties is calculated as the score of each of the processing blocks.

Further, at Step S1503 where the processing block to which each of the properties belongs is determined, another arrangement is acceptable in which the client terminal 100 extracts processing blocks for each of which a score equal to or higher than a predetermined threshold value has been calculated so that, if two or more such processing blocks have been extracted, the client terminal 100 determines the processing block having the highest priority level as the processing block to which the property belongs, by using the priority order determined at Step S1502.

Furthermore, at Step S1504 where the positional arrangement of the property columns is determined within each of the processing blocks, another arrangement is acceptable in which the client terminal 100 determines a positional arrangement of the property columns in such a manner that a property having a possibility of belonging also to the processing block that is positioned before or after the processing block is arranged so as to be in a position that is close to the processing block that is positioned before or after the processing block.

In the exemplary embodiments described above, at Step S1504 where the positional arrangement of the property columns is determined within each of the processing blocks, yet another arrangement is acceptable in which the client terminal 100 utilizes information that is set in the individual instance table in addition to the dictionary information stored in the dictionary storage unit 203. For example, in the case where the key information is set in the instance table as shown in FIG. 5, an arrangement is acceptable in which the client terminal 100 displays the key information at a head position and determines a positional arrangement of the property columns based on the key information and the scores of the remaining properties. Alternatively, in the case where any of various types of constraints such as a uniqueness constraint or a “NOT NULL” constraint is applied to the property columns, an arrangement is acceptable in which the client terminal 100 determines a positional arrangement of the property columns by giving a higher priority to the property having such a constraint applied thereto, among the properties having mutually the same score.

In the exemplary embodiment described above, the display data used for causing the display unit 103 to display a part of the property columns within the instance table in the initial state in which no instance has been registered is generated; however, the present invention is not limited to this example. Another arrangement is acceptable in which display data is generated for displaying a part of the property columns within an instance table in such a state where a number of instances have already been registered (e.g., data that the user has temporarily stored), so that the display unit 103 displays the information by using the generated display data. In this situation, an arrangement is acceptable in which, at Step S1206, the client terminal 100 uses a function of the positional arrangement information generating unit 207 and re-generates a positional arrangement of the property columns by using only information of the part of the processing blocks according to the registration state of the instances so that the client terminal 100 generates display data based on the re-generated positional arrangement.

Further, at Step S1504 where the positional arrangement of the property columns is determined within each of the processing blocks, yet another arrangement is acceptable in which the client terminal 100 extracts an editing status of the instances, which are the property values. In other words, the client terminal 100 may extract, as the editing status, information indicating which ones of the property values are registered in the instance table. In addition, the information storage unit 208 may store therein a plurality of pieces of positional arrangement information for each of the classes. In this situation, to generate the display data, the client terminal 100 may compare the editing status of the property values on each of the lines with the pieces of operation information that are associated with the class and generate display data used for causing the display unit 103 to display a part of the property columns shown in the instance table according to a positional arrangement determined based on one of the pieces of positional arrangement information that has been selected by estimating operations to be performed thereafter and estimating the one of the pieces of operation information to be referenced.

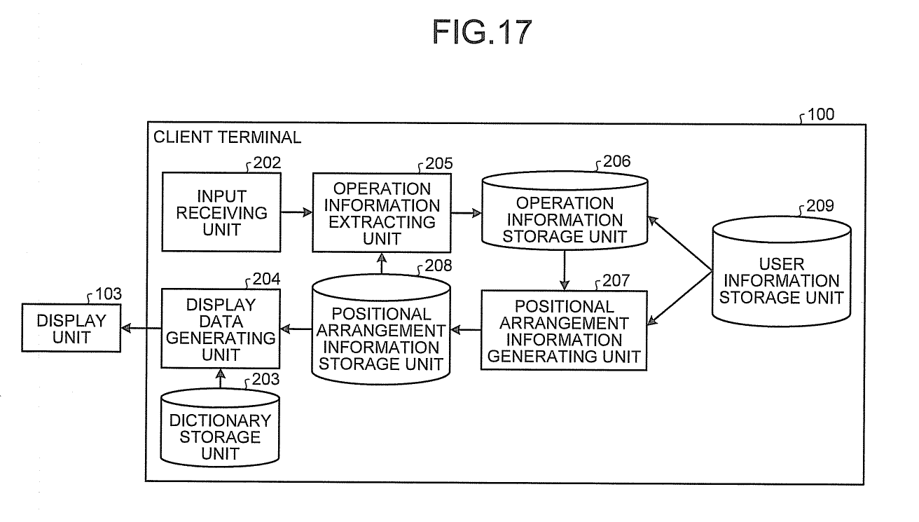

In the exemplary embodiments described above, during the positional arrangement information generating process shown in FIG. 13, the client terminal 100 uses the operation information stored in the operation information storage unit 206; however, the present invention is not limited to this example. Another arrangement is acceptable in which the client terminal 100 uses shared operation information that is managed in a shared space such as a server and is based on groups and/or roles of users. FIG. 17 is an exemplary functional diagram of the client terminal 100 according to the present modification example. The client terminal 100 includes a user information storage unit 209, in addition to the receiving unit 202, the dictionary storage unit 203, the display data generating unit 204, the operation information extracting unit 205, the operation information storage unit 206, the positional arrangement information generating unit 207, and the information storage unit 208. The user information storage unit 209 is stored in, for example, an external storage device such as an HDD or a storage device such as a RAM. The user information storage unit 209 stores therein user information for identifying a user who performs any of the various types of operations via the input device and role information indicating a role to which the user belongs, such as operations of which the user is in charge and the user's authority. The role of the user indicates, for example, whether the user is only able to browse the dictionary information or whether the user is able to register or delete the dictionary information. A role is specified for each of the users in advance. The receiving unit 202 receives, via the input device, an input of any of the various types of operations as well as an input of the user information of the user who has performed the operation. The operation information extracting unit 205 extracts specifics of any of the various types of operations that has been received by the receiving unit 202 as the input and generates operation information of a predetermined type of operation. The operation information extracting unit 205 then stores the generated operation information into the operation information storage unit 206 while associating the operation information with the class ID of the class that is the operation target and the role information associated with the user information that has been received by the receiving unit 202 as the input. In this situation, the positional arrangement information generating unit 207 reads the operation information that is stored in the operation information storage unit 206 while being associated with the operation target class that has been specified by the user via the input device and being associated with the role information corresponding to the user information of the user. The positional arrangement information generating unit 207 then performs the positional arrangement information generating process as described above. Another arrangement is also acceptable in which the user information storage unit 209 stores therein group information indicating a group to which the user belongs while associating the group information with the user information, in the same manner as the role information is stored. With these arrangements, it is possible to share the operation information among the plurality of users that belong to mutually the same group or mutually the same role. Thus, it is possible to display the information according to a positional arrangement that is suitable for an editing operation that is peculiar to the group or the role.

According to the conventional method by which a positional arrangement of the property columns is set according to how many times each of the properties has been accessed, moving of the property columns, the roles of the users, the editing status of the instance table at the point in time when the display data has been loaded are not taken into consideration. Thus, a problem remains where it is difficult to obtain a flexible positional arrangement of the property columns that is in compliant with an editing status of the user. However, according to the present modification example in which the various types of information described above are selectively applied, it is possible to display the property columns according to a positional arrangement that is suitable for the editing status of the user.

In the exemplary embodiments described above, another arrangement is acceptable in which, with regard to the positional arrangement information, the client terminal 100 expresses the positional arrangement of the property columns by using a query format. For example, the client terminal 100 may specify a property in a “Select” phrase in Structured Query Language (SQL), which is a query language used in relational databases, and may set and use various conditions in a “From” phrase and thereafter.

In the exemplary embodiments described above, another arrangement is acceptable in which, in the case where the judgment result at Step S602 is in the affirmative, the client terminal 100 causes the display unit 103 to display a dialogue to inquire of the user whether the information should be displayed by using the positional arrangement information stored in the information storage unit 208 while being associated with the class that is the operation target. In this situation, in the case where the user has input an affirmative response to the inquiry via the input device, the client terminal 100 generates, as explained above, the display data used for causing the display unit 103 to display a part of the property columns shown in the instance table according to the positional arrangement indicated by the positional arrangement information that is associated with the class that is the operation target and loads the generated display data into a storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for displaying instance data of a class in a table including a plurality of property columns comprising:
a receiving unit configured to receive an operation performed by a user;
an operation information generating unit configured to, in a case where the operation related to editing of property values or referencing of property values, generate operation information related to the operation while associating the operation information with one of the classes to which properties related to the operation belong;
a positional arrangement information generating unit configured to determine by the information, a positional arrangement of property columns and to generate positional arrangement information indicating the positional arrangement of the property columns in which the property value of the class are arranged for each of the properties;
an information storage unit configured to store therein the positional arrangement information while associating the same with the one of the classes; and
a display data generating unit configured to generate display data used for displaying the property columns of the one of the classes, based on the positional arrangement information.

2. The apparatus according to claim 1, further comprising a score calculator configured to, by using the information, calculate a score for each of the properties belonging to the one of the classes in accordance with at least one of an operation related to editing of property values and an operation related to referencing of property values that can have been performed in conjunction with an operation to move any of the property columns, and
the positional arrangement information generating unit determines the positional arrangement of the property columns of one of the classes by using the calculated scores.

3. The apparatus according to claim 1, further comprising a dictionary storage unit configured to store dictionary information including a hierarchical class structure based on an object-oriented method by which a class inherits all properties of its superclass, wherein
the display data generating unit generates the display data by using the dictionary information.

4. The apparatus according to claim 3, wherein
the dictionary information identifiably indicates both a parent-child relationship between classes and the one or more properties of each of the classes,
the apparatus for display further comprises a table generating unit configured to, by using the dictionary information, generate an instance table that shows instances including the property values of all or a part of the properties of the one of the classes by arranging the instances in the property columns, and
the display data generating unit generates the display data used for causing a display device to display the instance table, based on the positional arrangement information.

5. The apparatus according to claim 4, wherein
the receiving unit further receives an input that specifies one of the classes as an operation target, and
in a case where the positional arrangement information that is associated with the specified class is stored in the information storage unit, the display data generating unit generates the display data used for causing the display device to display the instance table according to the positional arrangement of the property columns indicated by the stored positional arrangement information.

6. The apparatus according to claim 5, wherein in a case where no positional arrangement information that is associated with the specified class is stored in the information storage unit, and also, the positional arrangement information that is associated with one of its superclasses is stored in the information storage unit, the display data generating unit generates the display data used for causing the display device to display the instance table according to the positional arrangement of the property columns indicated by the stored positional arrangement information of the superclass.

7. The apparatus according to claim 5, further comprising an editing status extracting unit configured to extract an editing status of property values in the instance table with respect to the specified class, wherein
the information storage unit stores therein a plurality of pieces of positional arrangement information for each of the classes, and
the display data generating unit obtains an editing status of each of the instances stored in the instance table out of one of the pieces of positional arrangement information that is stored in the information storage unit while being associated with the specified class and generates the display data used for causing the display device to display the instance table according to the positional arrangement of the property columns that is suitable for the editing status by estimating operations to be performed thereafter as a result comparison between the obtained editing status and the one of the pieces of positional arrangement information.

8. The apparatus according to claim 7, wherein the dictionary information further indicates a group to which each of the properties belongs, and
the positional arrangement information generating unit determines the positional arrangement of the property columns of the specified class by using the operation information and the group to which the properties belong.

9. The apparatus according to claim 5, wherein
the instance table has set therein key information used for identifying each of the instances as well as at least one of uniqueness constraint information defining that a value of the property of an instance does not duplicate a value of the property of another instance within the instance table and “NOT NULL” constraint information defining that each of the instances always has a value of the property, and
the positional arrangement determining unit determines the positional arrangement of the property columns of the specified class by using the operation information and the information that has been set in the instance table.

10. The apparatus according to claim 1, further comprising an operation information storage unit configured to store therein the operation information while associating the properties and the one of the classes that are related to the operation information.

11. The apparatus according to claim 10, wherein the operation information storage unit stores therein a plurality of pieces of operation information for each of the classes.

12. The apparatus according to claim 10, further comprising a user information storage unit configured to store therein user information used for identifying the user and role information indicating a role which is assigned to the user, while associating them with each other, wherein
the receiving unit receives an input of the user information, and
the operation information storage unit stores therein the operation information, the one of the classes, and the role information, while associating them with one another.

13. The apparatus according to claim 12, wherein the positional arrangement information generating unit determines the positional arrangement of the property columns of the one of the classes, by using the operation information that is stored in the operation information storage unit while being associated with the role information.

14. The apparatus according to claim 10, further comprising a group information storage unit configured to store therein user information used for identifying the user and group information indicating a group to which the user belongs, while associating them with each other, wherein
the receiving unit receives and input of the user information, and
the operation information storage unit stores therein the operation information, the one of the classes, and the group information, while associating them with one another.

15. The apparatus according to claim 1, wherein the positional arrangement information generating unit generates the positional arrangement information that is expressed in a query format.

16. The apparatus according to claim 1, further comprising a display device configured to display instances that include the property values of all the properties of the one of the classes and are editable according to a user's operation, by arranging the instances in the property columns.

17. The apparatus according to claim 16, wherein
the operation related to referencing of the property values is at least one of an operation to move any of the property columns and an operation to change a display area on the display device, and
in a case where the operation is an operation related to moving of any of the property columns, the operation information generating unit generates the operation information that indicates a property column that is an operation target, at least one of property columns that are positioned before and after the operation target property column, and property columns that are included in the display area after the moving operation has been performed,
in a case where the operation is an operation related to editing of the property values, the operation information generating unit generates the operation information that indicates a property column that is an operation target, and
in a case where the operation is an operation related to changing of the display area, the operation information generating unit generates the operation information that indicates property columns that are included in the display area and a positional arrangement thereof.

18. A method for displaying instance data by a display apparatus that displays the instance data of a class in a table including a plurality of property columns, wherein the apparatus comprises a an receiving unit, an operation information generating unit, a positional arrangement information generating unit, a information storage unit, and a display data generating unit,
the method comprising:
receiving, by the receiving unit, an operation performed by a user;
generating, by the operation information generating unit, in a case where the operation related to editing of property values or referencing of property values, generate operation information related to the operation while associating the operation information with one of the classes to which properties related to the operation belong;
determining, by the positional arrangement, a positional arrangement of property columns by the information,
generating, by the positional arrangement information generating unit, positional arrangement information indicating the positional arrangement of the property columns in which the property value of the class are arranged for each of the properties;
storing, by the information storage unit, the positional arrangement information while associating the same with the one of the classes; and
generating, by the display data generating unit, display data used for displaying the property columns of the one of the classes, based on the positional arrangement information.

19. A computer program product having a computer readable medium including programmed instructions that, when executed by a computer, cause the computer to perform for displaying instance data of a class in a table including a plurality of property columns:
receiving an operation performed by a user;
generating, in a case where the operation related to editing of property values or referencing of property values, generate operation information related to the operation while associating the operation information with one of the classes to which properties related to the operation belong;
determining, by the information, a positional arrangement of property columns;
generating positional arrangement information indicating the positional arrangement of the property columns in which the property value of the class are arranged for each of the properties;
storing the positional arrangement information while associating the same with the one of the classes; and
generating display data used for displaying the property columns of the one of the classes, based on the positional arrangement information.
